(19) United States
(12) Patent Application Publication
(10) Pub. No.: US 2019/0099040 A1
(43) Pub. Date: Apr. 4, 2019

(54) BARBECUE GRILL GRATE SYSTEM

(71) Applicant: Rodney Hopper, LAS VEGAS, NV (US)

(72) Inventor: Rodney Hopper, LAS VEGAS, NV (US)

(21) Appl. No.: 16/149,070

(22) Filed: Oct. 1, 2018

Related U.S. Application Data
(60) Provisional application No. 62/565,529, filed on Sep. 29, 2017.

(51) Int. Cl. A47J 37/07; A47J 36/02

(52) U.S. Cl. CPC A47J 37/07; A47J 36/025

(57) ABSTRACT

A barbecue grill grate system including a coated cooking grate having a plurality of cooking members defining a planar cooking surface. The coated cooking grate is configured to be removably placed on a barbecue-grill. The plurality of cooking members are arranged in a cross-section fashion in a grid-profile providing openings along the planar cooking surface to permit convection of heated air from a lower portion of the barbecue-grill to an upper portion of the barbecue-grill. The coated cooking grate includes a copper-infused-coating.

### CROSS REFERENCE TO RELATED APPLICATION

The present application is related to and claims priority to U.S. Provisional Patent Application No. 62/565,529 filed Sep. 29, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of grates and racks and more specifically relates to coated cooking grates.

### 2. Description of Related Art

Many people enjoy cooking on a barbecue grill. A barbecue grill is a device that cooks food by applying heat from below. There are several varieties of grills, with most falling into one of two categories: gas-fueled or charcoal. Gas-fueled grills typically use propane or natural gas as their fuel source, with gas-flame either cooking food directly or heating grilling elements which in turn radiate the heat necessary to cook food. Conventional barbeque grills come with factory steel grates or grates coated in a synthetic material. Food that is grilled on these grates often sticks, no matter what preemptive measures are taken. Not only does this make grilling difficult, but it also makes the clean-up time consuming and labor intensive. In addition, the steel grates have a tendency to rust over time and often require replacement. A suitable solution is desired.

U.S. Pat. No. 8,544,382 to Jie Zhao relates to a heat distributing cooking grate. The described heat distributing cooking grate discloses cooking grates for use in connection with grills, ovens and/or range tops. In one embodiment, the present invention relates to a cooking grate that is designed to be used in conjunction with a barbecue grill, where the cooking grate is designed to evenly distribute heat across the entire surface of the grate in order to eliminate, and/or reduce, any “hot” or “cold” spots thereon. In another embodiment, the present invention relates to a cooking grate that contains one or more heat transmitting members positioned in such a manner that heat is transmitted from the central portion of the cooking grate to the edge portions thereof, thereby facilitating a more even heat distribution across the entire cooking surface of the cooking grate.

### BRIEF SUMMARY OF THE INVENTION

In view of the foregoing disadvantages inherent in the known grates and racks art, the present disclosure provides a novel barbecue grill grate system. The general purpose of the present disclosure, which will be described subsequently in greater detail, is to provide a grilling accessory designed to offer a non-stick cooking surface.

A barbecue grill grate system is disclosed herein. The barbecue grill grate system includes a coated cooking grate having a plurality of cooking members. The coated cooking grate is configured to be removably placed on a barbecue-grill. The coated cooking grate includes the plurality of cooking members defining a planar cooking surface. The planar cooking surface is configured to match a profile of an opening of the barbecue-grill. The plurality of cooking members include a series of parallel-members and a series of perpendicular members which are configured in a cross-section fashion in a grid-profile providing openings along the planar cooking surface to permit convection of heated air from a lower portion of the barbecue-grill to an upper portion of the barbecue-grill. The coated cooking grate includes a copper-infused-coating. The copper-infused-coating further comprises a non-stick material. The barbecue grill grate system provides a non-stick grill grate for efficiently grilling items.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a barbecue grill grate system, constructed and operative according to the teachings of the present disclosure.

FIG. 1 is perspective view of the barbecue grill grate system during an ‘in-use’ condition, according to an embodiment of the disclosure.

FIG. 2 is a perspective view of the barbecue grill grate system of FIG. 1, according to an embodiment of the present disclosure.

FIG. 3 is a perspective view of the barbecue grill grate system of FIG. 1, according to an embodiment of the present disclosure.

FIG. 4 is a perspective view of the barbecue grill grate system of FIG. 1, according to an embodiment of the present disclosure.

FIG. 5 is a perspective view of the barbecue grill grate system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a grates and racks and more particularly to a barbecue grill grate system as used to improve cooking efficiency on a barbecue grill by providing a non-stick grill grate that comprises steel and a copper infused coating.

Generally, the present invention includes an aftermarket barbeque grill grate which replaces the factory steel or synthetic coated grill grates commonly used. This further prevents food from sticking to the surface of the grill grate during cooking. It offers an easy-to-clean, non-stick surface, saving users time and energy. The present invention affords adjustable grates that can be adjusted to fit odd sized grills. Barbecue grill grate system is a grilling accessory designed to offer a non-stick cooking surface. The invention is comprised of copper infused/coated grill grates made using high quality steel rods welded in a cross fashion to ensure long lasting joints and then coated with a copper infused coating. These may be made in round or square models. Another variation is made using cast steel grates with the copper infused coating. A third variation available for square grates is an adjustable grate option made of high-quality steel rods, where sliding half-moon rods would fit over the solid rod so that it can be adjusted to fit different sized grills.

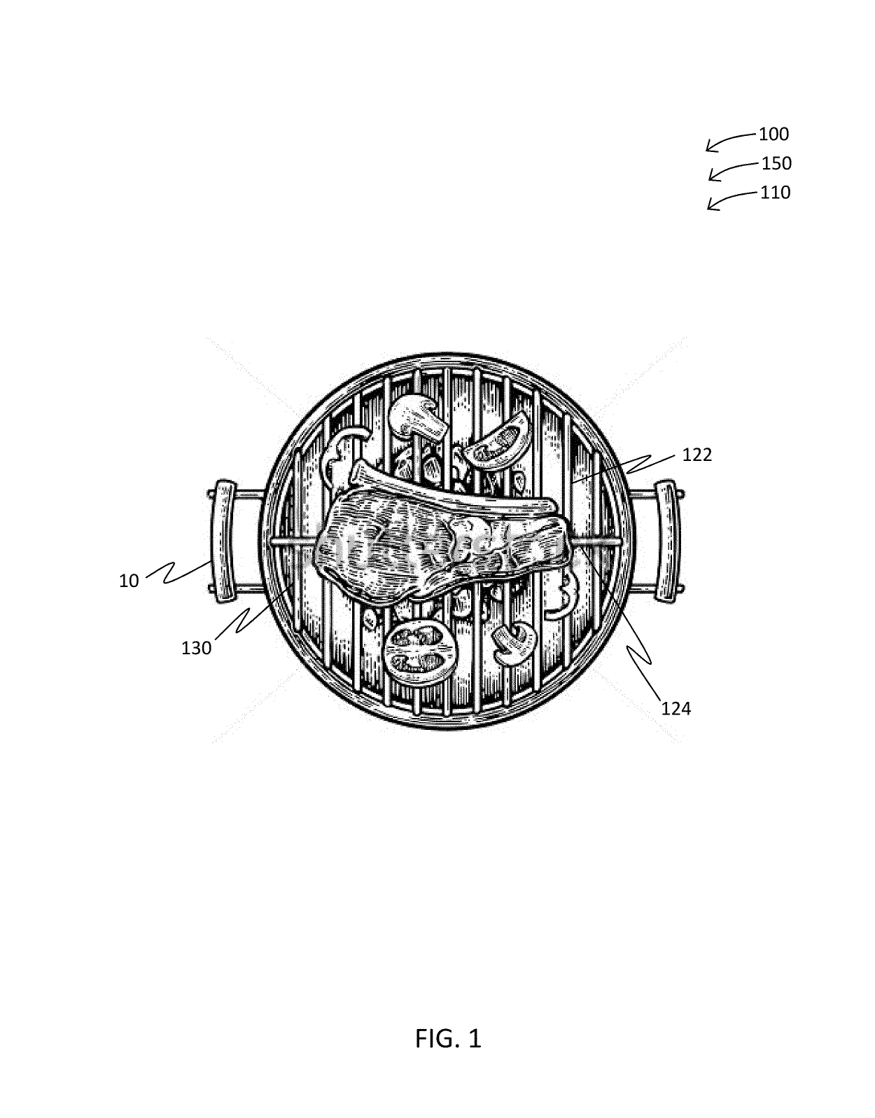

Referring now more specifically to the drawings by numerals of reference, there is shown in FIGS. 1-5, various views of a barbecue grill grate system 100. FIG. 1 shows a barbecue grill grate system 100 during an ‘in-use’ condition 150, according to an embodiment of the present disclosure. As illustrated, the barbecue grill grate system 100 may include a coated cooking grate 110 having a plurality of cooking members 120 forming a planar cooking surface 130. The device provides a non-stick cooking surface for use with a barbecue-grill 10.

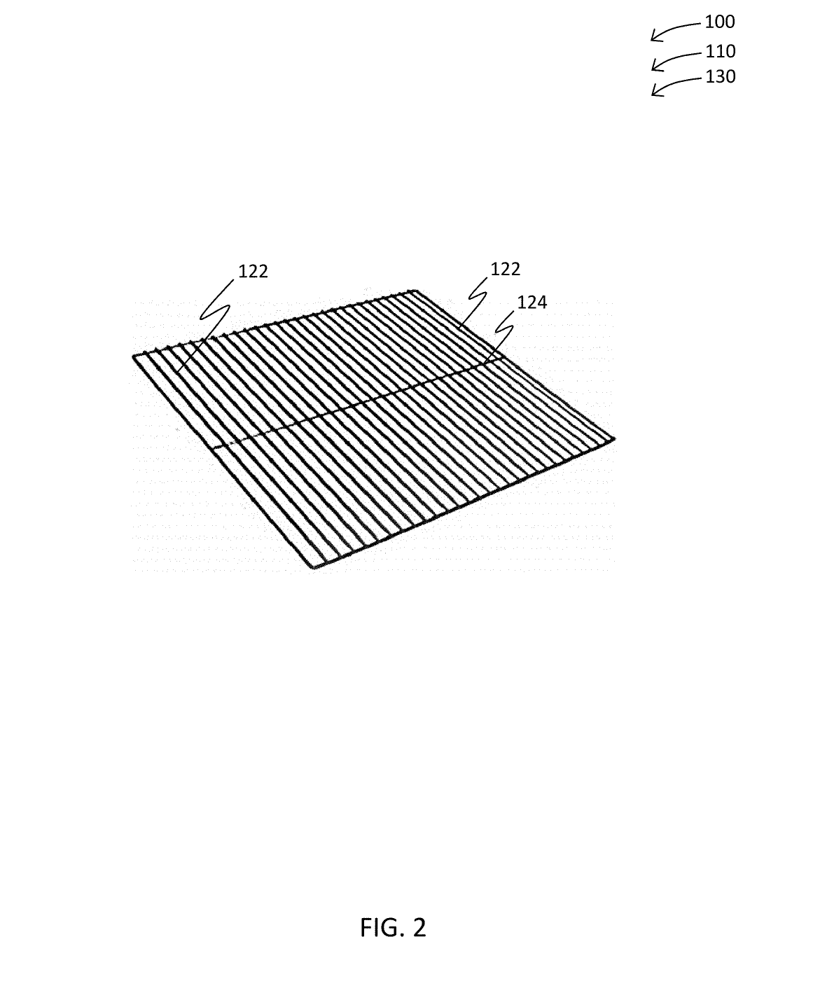

FIG. 2 shows a perspective view of the barbecue grill grate system 100 of FIG. 1, according to an embodiment of the present disclosure. As above, the barbecue grill grate system 100 may include the coated cooking grate 110 having the plurality of cooking members 120. The coated cooking grate 110 is configured to be removably placed on a barbecue-grill 10. The coated cooking grate 110 includes the plurality of cooking members 120 defining the planar cooking surface 130. The plurality of cooking members 120 are configured in a cross-section fashion in a grid-profile providing openings along the planar cooking surface 130 to permit convection of heated air from a lower portion of the barbecue-grill 10 to an upper portion of the barbecue-grill 10. The coated cooking grate 110 includes a copper-infused-coating 140.

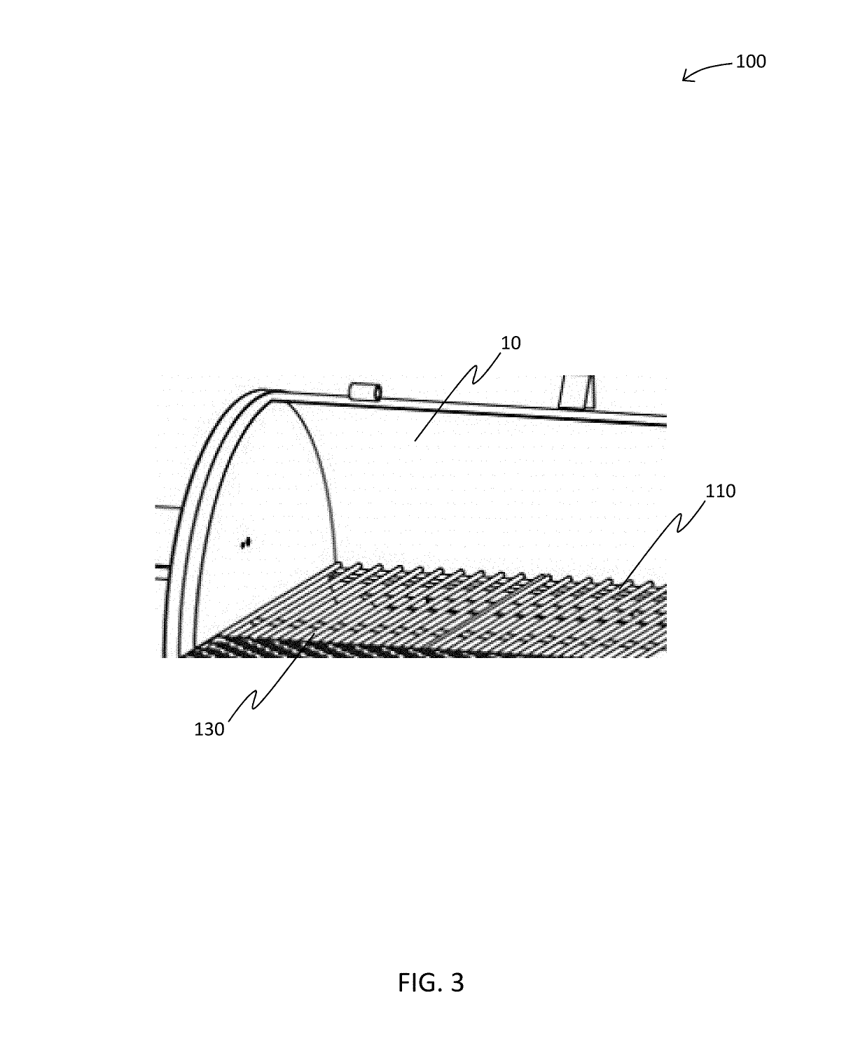

FIG. 3 shows a perspective view of the barbecue grill grate system 100 of FIG. 1, according to an embodiment of the present disclosure. As above, the barbecue grill grate system 100 may include the coated cooking grate 110 having the plurality of cooking members 120 including a series of parallel-members 122 and a series of perpendicular members 124 forming the grid profile. Each one of the series of parallel-members 122 is equidistantly spaced from one another. The planar cooking surface 130 further includes a plurality of joints 126 which are weld-fastened together to form the cross-section fashion of the planar cooking surface 130. The welded joints 126 of the cross-sections of the series of parallel-members 122 and the series of perpendicular members 124 provide structural integrity to the coated cooking grate 110. The coated cooking grate 110 is designed to support a variety of food items thereon for grilling.

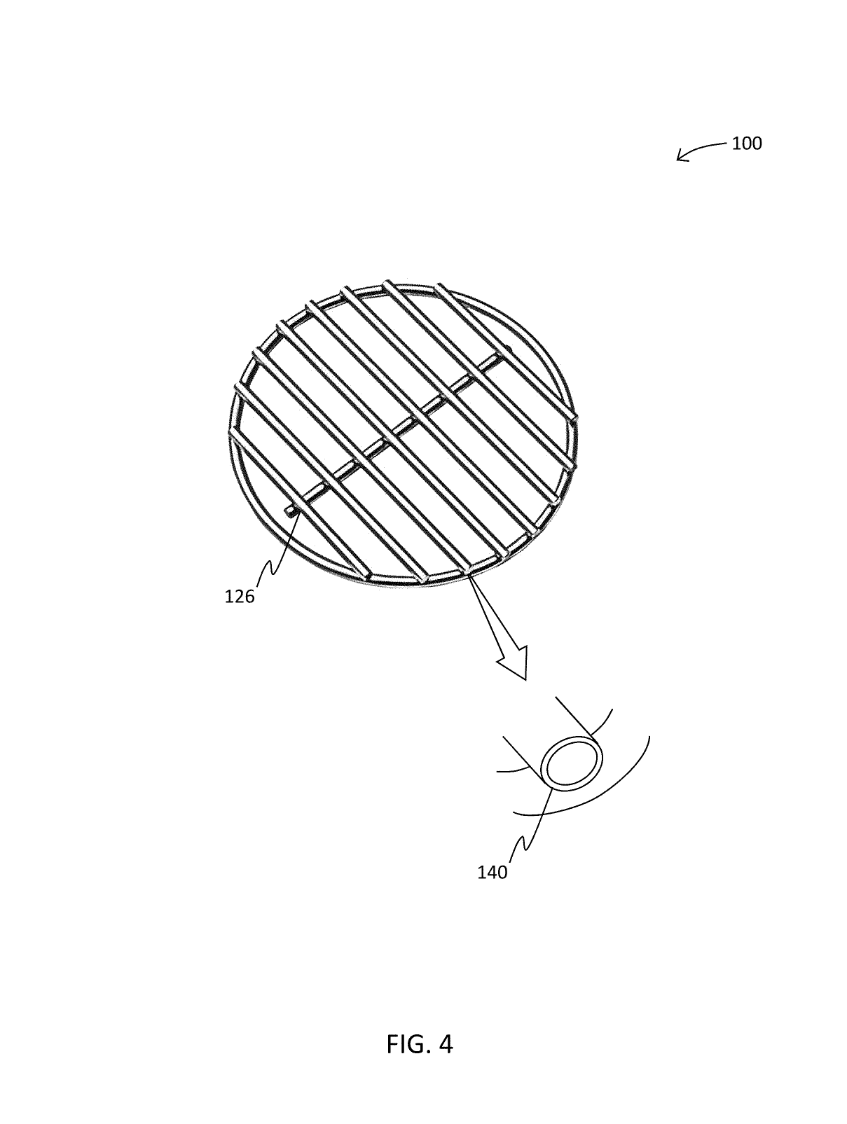

FIG. 4 shows a perspective view of the barbecue grill grate system 100 of FIG. 1, according to an embodiment of the present disclosure. As above, the barbecue grill grate system 100 may include the coated cooking grate 110 having a copper-infused-coating 140. The copper-infused-coating 140 comprises a non-stick material. The plurality of cooking members 120 comprise steel. In certain embodiments, the plurality of cooking members 120 comprise cast-steel with the copper-infused-coating. The copper-infused-coating 120 includes a thermal conductor which conducts heat energy for cooking purposes. The planar cooking surface 130 evenly distributes the heat energy.

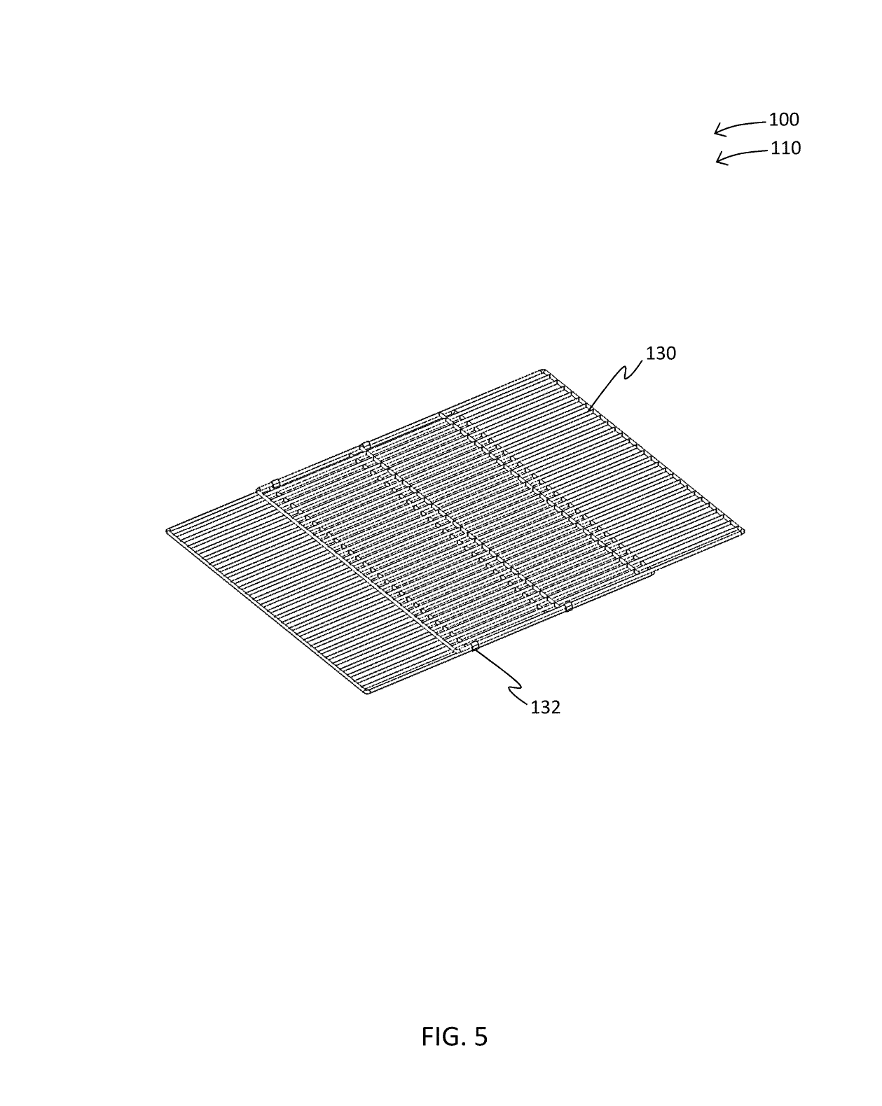

FIG. 5 shows a perspective view of the barbecue grill grate system 100 of FIG. 1, according to an embodiment of the present disclosure. As above, the barbecue grill grate system 100 may include the planar cooking surface 130 is configured to match a profile of an opening of the barbecue-grill 10. The coated cooking grate 110 is an aftermarket item which is retrofitted to the barbecue-grill 10. In various embodiments, the planar cooking surface 130 may include a circular profile or a square profile. In certain embodiments, the planar cooking surface 130 is adjustable and includes adjustable bars 132. The adjustable bars 132 are configured to extend and retract in relation to the coated cooking grate 110 to accommodate a plurality of sized the barbecue-grills 10. The adjustable bars 132 may include half-moon rods configured to work simultaneously with the existing body of the planar cooking surface 130.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A barbecue grill grate system comprising:
a coated cooking grate having;
a plurality of cooking members;
wherein said coated cooking grate is configured to be removably placed on a barbecue-grill;
wherein said coated cooking grate includes said plurality of cooking members defining a planar cooking surface;
wherein said plurality of cooking members are configured in a cross-section fashion in a grid-profile providing openings along said planar cooking surface to permit convection of heated air from a lower portion of said barbecue-grill to an upper portion of said barbecue-grill; and
wherein said coated cooking grate includes a copper-infused-coating.

2. The barbecue grill grate system of claim 1, wherein said planar cooking surface includes a plurality of joints.

3. The barbecue grill grate system of claim 2, wherein said plurality of joints are weld-fastened together to form said cross-section fashion of said planar cooking surface.

4. The barbecue grill grate system of claim 1, wherein said planar cooking surface is configured to match a profile of an opening of said barbecue-grill.

5. The barbecue grill grate system of claim 4, wherein said planar cooking surface comprises a circular profile.

6. The barbecue grill grate system of claim 4, wherein said planar cooking surface comprises a square profile.

7. The barbecue grill grate system of claim 6, wherein said planar cooking surface is adjustable.

8. The barbecue grill grate system of claim 7, wherein said planar cooking surface further includes adjustable bars.

9. The barbecue grill grate system of claim 8, wherein said adjustable bars are configured to extend and retract in relation to the coated cooking grate to accommodate a plurality of sized said barbecue-grills.

10. The barbecue grill grate system of claim 9, wherein said adjustable bars include half-moon rods.

11. The barbecue grill grate system of claim 1, wherein said copper-infused-coating comprises a non-stick material.

12. The barbecue grill grate system of claim 1, wherein said plurality of cooking members comprise steel.

13. The barbecue grill grate system of claim 1, wherein said plurality of cooking members comprise cast-steel with said copper-infused-coating.

14. The barbecue grill grate system of claim 1, wherein said copper-infused-coating includes a thermal conductor which conducts heat energy for cooking purposes.

15. The barbecue grill grate system of claim 14, wherein said planar cooking surface evenly distributes said heat energy.

16. The barbecue grill grate system of claim 1, wherein said plurality of cooking members include a series of parallel-members and a series of perpendicular members forming said grid profile.

17. The barbecue grill grate system of claim 16, wherein each one of said series of parallel-members is equidistantly spaced from one another.

18. The barbecue grill grate system of claim 1, wherein said coated cooking grate is retrofitted to said barbecue-grill.

19. A barbecue grill grate system, the barbecue grill grate system comprising:
a coated cooking grate having;
a plurality of cooking members;
wherein said coated cooking grate is configured to be removably placed on a barbecue-grill;
wherein said coated cooking grate includes said plurality of cooking members defining a planar cooking surface;
wherein said plurality of cooking members are configured in a cross-section fashion in a grid-profile providing openings along said planar cooking surface to permit convection of heated air from a lower portion of said barbecue-grill to an upper portion of said barbecue-grill;
wherein said coated cooking grate includes a copper-infused-coating;
wherein said planar cooking surface includes a plurality of joints;
wherein said plurality of joints are weld-fastened together to form said cross-section fashion of said planar cooking surface;
wherein said planar cooking surface is configured to match a profile of an opening of said barbecue-grill;
wherein said copper-infused-coating comprises a non-stick material;
wherein said plurality of cooking members comprise steel;
wherein said copper-infused-coating includes a thermal conductor which conducts heat energy for cooking purposes;
wherein said planar cooking surface evenly distributes said heat energy;
wherein said plurality of cooking members include a series of parallel-members and a series of perpendicular members forming said grid profile;
wherein each one of said series of parallel-members is equidistantly spaced from one another; and
wherein said coated cooking grate is retrofitted to said barbecue-grill.
